(19) United States
(12) Patent Application Publication
(10) Pub. No.: US 2005/0257976 A1
(43) Pub. Date: Nov. 24, 2005

(54) Motor vehicle cruise control speed memory system

(76) Inventor: Christopher Moczydlowski, Yonkers, NY (US)

Correspondence Address: THE INVENTORS NETWORK, INC., 332 ACADEMY STREET, CARNEGIE, PA, 15106, US

(21) Appl. No.: 10/850,389

(22) Filed: May 21, 2004

(51) Int. Cl. B60K 31/00

(52) U.S. Cl. 180/170

(57) ABSTRACT

A vehicle speed control memory system includes a microprocessor for storing various operator selected vehicle speed settings in memory thus allowing the operator to set the various speeds for the cruise control system, and then as the vehicle enters different speed limit zones, such as would occur on long trips through both rural and urban areas, the operator can increase or decrease vehicle speed by actuating the appropriate memory buttons corresponding to the previously selected vehicle speed settings for achieving and maintaining the desired speed.

### FIELD OF THE INVENTION

The present invention pertains to cruise control systems for motor vehicles, and more particularly pertains to a cruise control system capable of storing and recalling various stored speed settings for increasing or decreasing vehicle speed to match the given speed limit zone.

### BACKGROUND OF THE INVENTION

Numerous makes and models of motor vehicles come with a cruise control function that allows the operator to maintain a set speed without continuously depressing the accelerator. The cruise control system thus maintains the vehicle speed at the desired speed without operator intervention. In order to activate the cruise control system, the operator accelerates the vehicle to the desired velocity, and upon reaching that velocity, actuates a switch or setting means so that the throttle valve of the engine is automatically controlled through the cruise control system monitoring the difference between the desired speed and the actual speed in order to maintain the desired speed. However, such cruise control systems are not capable of maintaining the desired speed when the engine is operating outside of the predetermined limits. Such a situation occurs when the vehicle is ascending, descending and traversing hilly or mountainous terrain. Another situation where the vehicle speed diverges from the set speed occurs when the vehicle is traveling through numerous zoned speed limits, with the speed limits for each zone varying widely from each other. The operator has no choice but to set a desired new speed each time the operator enters a new speed limit zone if the operator wants to utilize the cruise control system. However, this can be an irksome and even dangerous activity. The prior art therefore discloses a number of cruise control arrangements and systems that attempt to rectify this—and other attendant—problems with current cruise control systems.

For example, the Hayama et al. patent (U.S. Pat. No. 4,736,813) discloses a cruise control system for vehicles that minimizes the shock effects occurring at the beginning of acceleration or deceleration by automatically increasing or decreasing the throttle opening.

The Moncelle et al. patent (U.S. Pat. No. 4,914,597) discloses an engine cruise control that includes a memory for storing data sets that are retrieved for controlling the rate of fuel delivery to the engine during downshifting.

The White et al. patent (U.S. Pat. No. 5,393,277) discloses an engine-transmission control system for providing variable shift points includes equations that generate up shift and downshift signals that actuate gear ratio operation states for automatically controlling vehicle speed and transmission shifting.

The Grahn et al. patent (U.S. Pat. No. 5,567,992) discloses a cruise control system for a motor vehicle that includes a two-position switch to switch off the cruise control without canceling a vehicle set speed, or for causing the cruise control system to access a set speed stored in a control unit.

The Sakonjyu et al. patent (U.S. Pat. No. 5,749,063) discloses a vehicle speed controlling apparatus that includes a cruise control governor that dynamically defines and switches between droop curves, i.e. various plots of engine torque versus vehicle speed as the vehicle ascends and descends hills.

Despite the ingenuity of the above devices there remains a need for a cruise control system that allows the system to store numerous speed settings so that vehicle speed can be automatically increased or decreased while using the cruise control system.

### SUMMARY OF THE INVENTION

The present invention comprehends an automotive vehicle cruise control speed memory system that allows the operator to store numerous speed settings in the memory unit of a microprocessor. The speed memory system permits the operator to change the vehicle speed while using the cruise control thus permitting the vehicle speed to increase or decrease while driving through different speed limit zones. The present invention provides for at least ten different speed settings that can be set and stored in memory as desired by the operator. After the desired speed—or speeds—settings have been selected and set, the operator can activate the cruise control and then depress the corresponding memory button to achieve the desired speed. A control module in the form of a microprocessor provides the interface between the speed and memory settings and the vehicle system parameters such as the speed sensor, the tachometer, the vehicle brake, the accelerator position feedback and the automatic transmission downshift.

It is an objective of the present invention to provide a cruise control speed memory system that allows at least ten different speed settings to be stored and selected for use by the cruise control system.

It is another objective of the present invention to provide a cruise control speed memory system that allows the operator to automatically change the speed of the vehicle to match the speed limit zone while utilizing the cruise control system.

It is yet another objective of the present invention to provide a cruise control speed memory system that obviates the need to manually set a new speed each time a new speed limit zone is entered or exited.

Still yet another objective of the present invention is to provide a cruise control speed memory system that is especially suitable for long distance travelers that pass through different speed zones where the speed limits are subject to numerous changes.

Still another objective of the present invention is to provide a cruise control speed memory system wherein each change in vehicle speed can be set by the operator pushing a button.

These and other objects, features and advantages will become apparent to those skilled in the art upon a perusal of the following detailed description read in conjunction with the accompanying drawing figures.

### BRIEF DESCRIPTION OF THE DRAWINGS

FIG. 1 is a perspective view of the motor vehicle cruise control speed memory system of the present invention illustrating the panel layout of the cruise control system on the motor vehicle steering wheel;

FIG. 2 is an enlarged perspective view of the motor vehicle cruise control speed memory system of the present invention illustrating the memory and set push buttons for setting and storing the various speed settings;

FIG. 3 is a schematic layout of the motor vehicle cruise control speed memory system of the present invention illustrating the interconnection between the memory and speed settings; and

FIG. 4 is a schematic plan view of the motor vehicle cruise control speed memory system of the present invention illustrating the speed and memory settings and the vehicle parameters that are input to and output from the control module.

### DETAILED DESCRIPTION OF THE PREFERRED EMBODIMENT

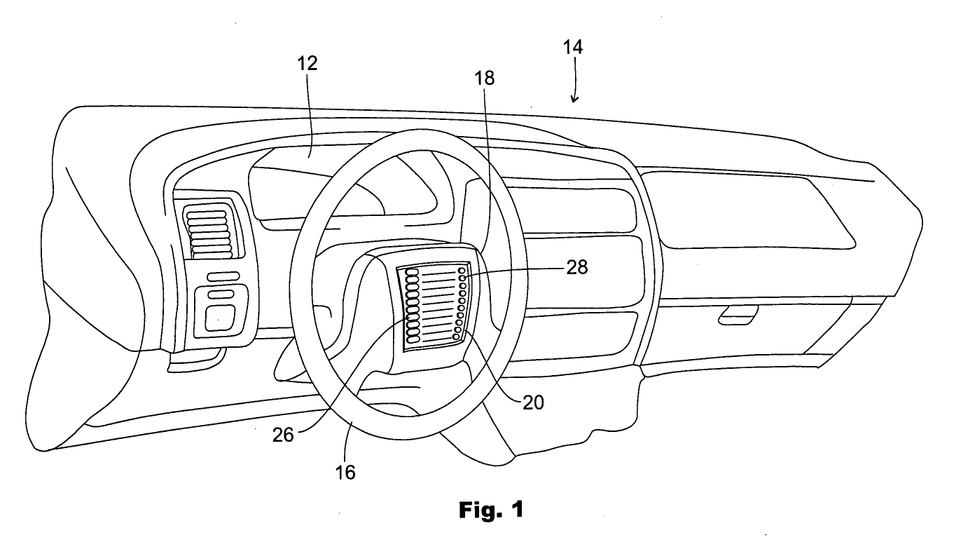

Illustrated in FIGS. 1-4 is an automotive vehicle cruise control speed memory system 10 that allows the operator to set different speed settings for the cruise control system, and then change—by increasing or decreasing—those speed settings as driving conditions warrant by pushing the appropriate button. The operator is able to maintain the appropriate speed within any given speed limit zone while in cruise control without having to manually set the new speed to maintain the cruise control every time the vehicle enters a different speed limit zone.

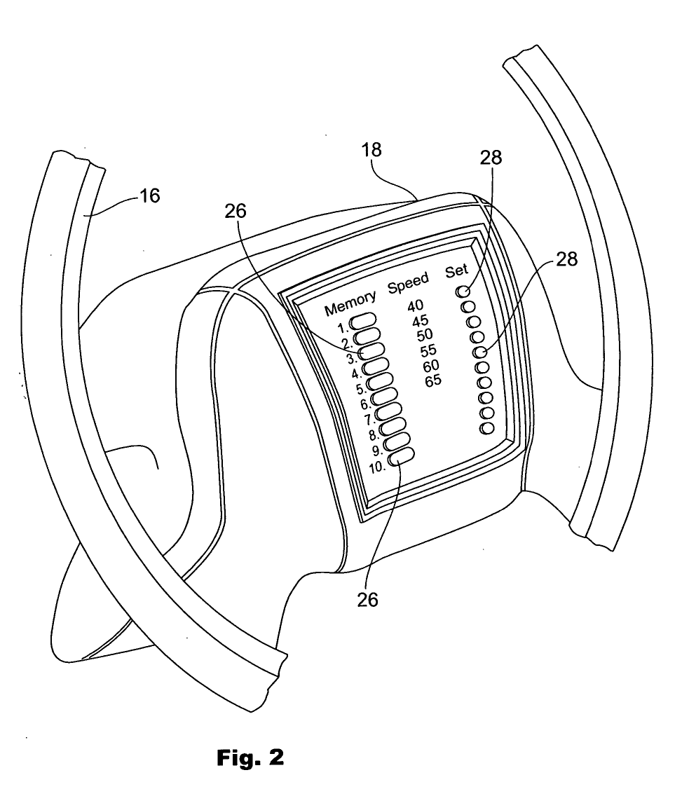

Thus, shown in FIGS. 1 and 2 are the operator manipulable physical features and elements of the vehicle cruise control speed memory system 10. FIG. 1 illustrates the dashboard 12 of an automotive vehicle 14 and a steering wheel 16 projecting from the dashboard 12. Mounted on the hub 18 of the steering wheel 16 is a speed memory system operator control panel 20. The speed memory system panel 20 is electrically integrated and interconnected with the automotive vehicle's electrical system and with a control unit or module 22 that includes a microprocessor 24 for receiving various vehicle and operator inputs via through speed memory system panel 20 in order to increase, decrease or maintain vehicle speed while using the cruise control.

As shown in FIGS. 1 and 2, the speed memory system panel 20 includes a plurality of memory buttons 26 and a plurality of speed set buttons 28 with each memory button 26 corresponding to one respective speed set button 28. Each speed set button 28 can be set at a different speed for the cruise control system, and for the present embodiment the vehicle speed settings commence at 40 mph and continue upward in 5 mph increments so that ten different speed settings are available for the operator. The microprocessor 24 includes a memory unit or module 30 wherein the various speed settings can be stored and recalled by the operator at any time by pressing the appropriate memory button 26.

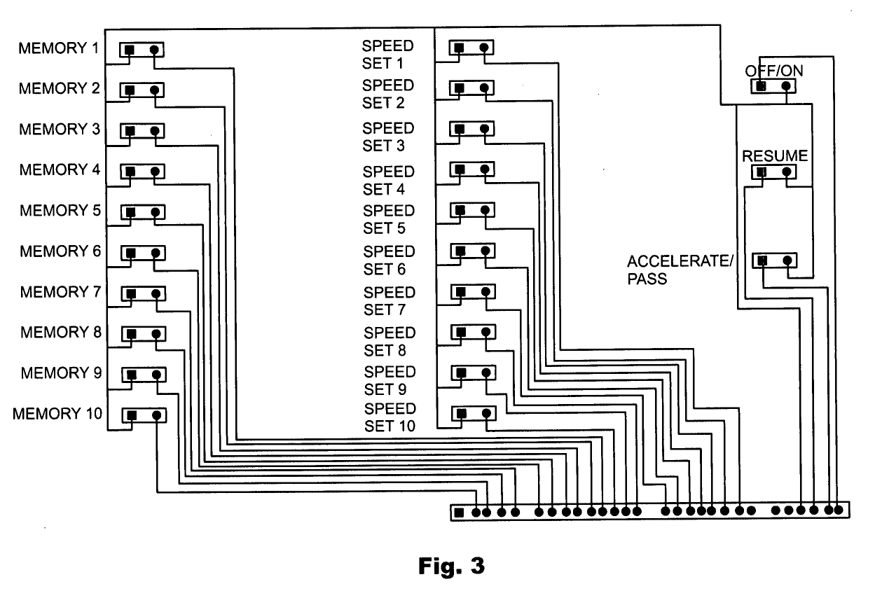

FIG. 3 illustrates a schematic layout 32 showing the interrelationship between the memory buttons 26 and the speed set buttons 28 with each memory button 26 having a corresponding speed set button 28. In addition, the memory buttons 26 and the speed set buttons 28 are electrically interconnected to the cruise control on/off switch 34, a cruise control resume function 36, and an accelerate/pass function 38—all of which can be inputs to the microprocessor 24.

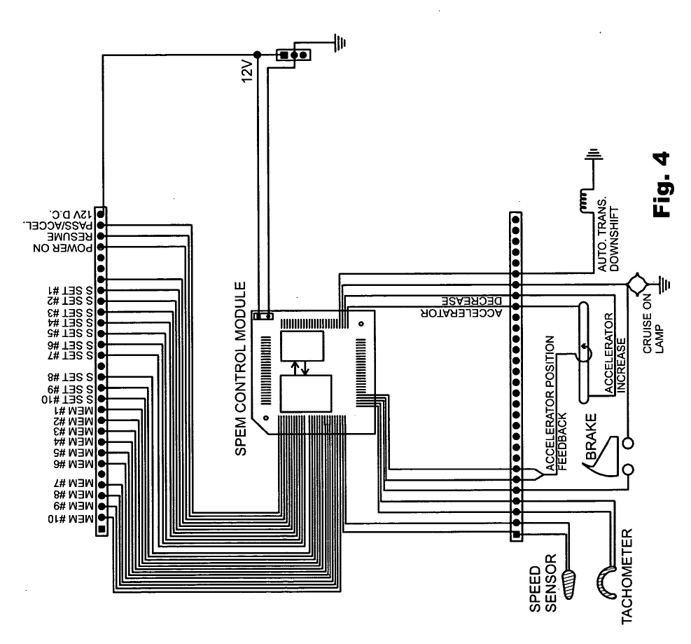

FIG. 4 shows how the control module 22 containing the microprocessor 24 interconnects with the memory buttons 26 and the speed set buttons 28; and the various vehicle system parameters that are continuously monitored and evaluated so that the vehicle 14 can attain and maintain the desired speed while using the cruise control system. The vehicle system parameters and elements that provide both the inputs and outputs for the control module 22 and the microprocessor 24 include a vehicle speed sensor 40, a tachometer 42, the vehicle brake 44, the accelerator feedback position 46 that includes an accelerator increase output 48 an accelerator decrease output 50, the cruise control on lamp 52, and the automatic transmission downshift 54. The control module 22 can be powered from a 12 v power source 56.

In operation the speed set buttons 28 can be set as desired by the operator, and after the speed set buttons 28 have been set the operator activates the cruise control and when a certain speed is desired that is appropriate for that speed limit zone, the operator pushes the requisite memory button 26 to attain the desired speed. More specifically, with reference to FIG. 4, when one set button 28 is pressed the microprocessor 24 evaluates values representing the engine rpm's through monitoring of the tachometer 42, the accelerator position 46, and the vehicle speed through evaluation of the values received from the vehicle speed sensor 40. These are inputs to the control module 22 and the values of these inputs are placed into the memory unit 30 of the control module 22. The vehicle accelerator 46 is now controlled by a P.I.D. loop under the control of the microprocessor 24 that matches the above three inputs with values stored in the memory unit 30 in order to determine which output to apply: that is, the accelerator increase 48 or accelerator decrease 50. When one memory button 26 is pressed, the microprocessor 24 evaluates values representing the engine rpm's through the tachometer 42, the accelerator position 46, and the vehicle speed through the vehicle speed sensor 40. The microprocessor 24 then compares the values of these system parameters with values stored in memory at any given point in the vehicle's 14 operation. The accelerator 46 will now be controlled by the P.I.D. loop that is under control of the microprocessor 24. The microprocessor 24 then matches the values of the three aforedescribed inputs—the engine rpm's, the accelerator position 46, and the vehicle speed—with values stored in the memory unit 30 so that the microprocessor 24 can then select the output to apply—accelerator increase 48 or accelerator decrease 50—so that the vehicle speed can be increased or decreased as desired and needed to bring the vehicle speed in accord with the speed limit zone the vehicle 14 will be entering and traveling through.

While the invention has been described and illustrated in detail in the drawings and the foregoing description, it is considered as illustrative and not restrictive in character as it is understood that only the preferred embodiment has been shown and described and that all changes and modifications that come within the spirit of the invention and the scope of the appended claims are intended to be protected.

1. A speed memory system for use with the cruise control system of an automotive vehicle for maintaining the desired vehicle speed through the cruise control system while passing through different speed limit zones, comprising:
a control module including a microprocessor and a memory unit that are electrically interconnected;
a speed memory system panel mounted on the steering wheel of the automotive vehicle;
the speed memory system panel having a plurality of speed set buttons with each speed set button for setting a discrete vehicle speed setting, and a plurality of memory buttons with each memory button interconnected through the control module to the corresponding speed set button so that pressing the respective memory button initiates the speed setting of the corresponding speed set button; and
after the selected speed set buttons have been set and the cruise control system engaged, the desired vehicle speed can be attained by engaging the appropriate memory buttons as the automotive vehicle enters and leaves the different speed limit zones.

2. The speed memory system for use with the cruise control of an automotive vehicle of claim 1 further comprising a vehicle speed sensor for continuously sensing the vehicle speed and transmitting the vehicle speed as a system input to the control module.

3. The speed memory system for use with the cruise control of an automotive vehicle of claim 2 further comprising a tachometer that provides engine rpm input values to the control module.

4. The speed memory system for use with the cruise control of an automotive vehicle further comprising an accelerator feedback position that provides input values to the control module so that the control module can evaluate the vehicle speed values, the engine rpm values, and the accelerator position to determine whether the accelerator increase or the accelerator decrease function should be initiated so that the cruise control speed matches the speed limit zone.
